(19) United States
(12) Patent Application Publication
(10) Pub. No.: US 2025/0269618 A1
(43) Pub. Date: Aug. 28, 2025

(54) Method and cord organizer for organizing cords between a tire building creel and an extruder

(71) Applicant: VMI Holland B.V., EPE (NL)

(72) Inventors: Gerardus Johannes Catharina VAN LAAR, EPE (NL); Jantinus SCHRAA, EPE (NL)

(21) Appl. No.: 18/858,217

(22) PCT Filed: Apr. 12, 2023
(86) PCT No.: PCT/NL2023/050190

§ 371 Date: Oct. 18, 2024

(30) Foreign Application Priority Data
May 18, 2022 (NL) 2031910

(51) Int. Cl. B29D 30/38; B65H 51/18; B65H 57/16

(52) U.S. Cl. CPC B29D 30/38; B65H 51/18; B65H 57/16; B29D 2030/381; B65H 2701/36; B65H 2701/38; B65H 2801/93

(57) ABSTRACT

Disclosed are a method and a cord organizer for organizing cords between a tire building creel and an extruder, wherein the method includes the steps of:
providing a cord inlay station between the tire building creel and the extruder for preparing the cords for insertion into the extruder;
collecting groups of the cords in a plurality of cord collectors at the tire building creel; and
transferring said plurality of cords collectors with the groups of cords collected therein from the tire building creel towards the cord inlay station.

### BACKGROUND

The invention relates to a method and a cord organizer for organizing cords between a tire building creel and an extruder.

WO 2018/182410 A1 discloses a creel that holds a plurality of creel bobbins, each storing a length of a cord. The creel bobbins feed their cords via guide tubes at the top and the bottom of the creel to sets of collector rollers deflecting the cords towards a central cord collector. The cord collector collects all the cords originating from the individual creel bobbins and distributes the collected cords in a mutually parallel orientation within a cord plane towards an extruder head where the cords are embedded in elastomeric material to form a cord-reinforced tire component.

### SUMMARY OF THE INVENTION

With tire designs featuring increasingly wider tires, cord-reinforced tire components have grown increasingly wider as well, embedding more and more reinforcement cords.

A disadvantage of the collector rollers, the cord collector and the extruder head as disclosed in WO 2018/182410 A1 is that each features channels, grooves or holes for receiving individual cords and that, as a consequence, each cord has to be manually picked up from the creel and has to be guided, individually and with care not to misplace or to cross any cords, along a path dedicated to the respective cord.

With the increasingly higher number of cords originating from creels, the time required to manually prepare the cords for embedding is increasing significantly and delays any tire building processes downstream of the extruder.

It is an object of the present invention to provide a method and a cord organizer for organizing cords between a tire building creel and an extruder, wherein the amount of manual labor required to prepare the cords for embedding can be reduced.

According to a first aspect, the invention provides a method for organizing cords between a tire building creel and an extruder, wherein the method comprises the steps of:
providing a cord inlay station between the tire building creel and the extruder for preparing the cords insertion into the extruder;
collecting groups of the cords in a plurality of cord collectors at the tire building creel; and
transferring said plurality of cords collectors with the groups of cords collected therein from the tire building creel towards the cord inlay station.

The cords can be collected in a decentralized manner with the use of the cord collectors, and can be transferred, in groups, to the cord inlay station. This is considerably less labor intensive compared to individually collecting and transferring the cords from the tire building creel to the extruder according to the prior art.

In a preferred embodiment the method further comprises the step of:
receiving the plurality of cord collectors in a collector frame. The cords may conveniently remain in groups in the cord collectors when said cord collectors are received in the collector frame. Hence, the cord can be prepared in a much more organized manner for mutually parallel distribution in a common cord plane towards the cord inlay station and/or the extruder, compared to the individual preparation of cords according to the prior art.

More preferably, the method further comprises the steps of:
preparing the cords in the cord inlay station for mutually parallel insertion in a common cord plane into the extruder; and
stacking at least two cord collectors of the plurality of cord collectors in the collector frame in a stacking direction perpendicular to the cord plane; and/or
juxtaposing at least two cord collectors of the plurality of cord collectors in the collector frame in a lateral direction parallel to the cord plane. By stacking and/or juxtaposing the cord collectors in the collector frame, a relative large amount of cord collectors can be received in a single collector plane to feed all of the cords collected therein to the cord inlay station from said collector plane.

In another embodiment each cord collector of the plurality of cord collectors comprises a collector body and a plurality of collection channels extending in a collection direction through said collector body, wherein the method further comprises the step of:
for each cord collector of the plurality of cord collectors, threading each cord of a respective group of cords through a different collection channel of the plurality of collection channels in the collection direction. By threading each cord through a different collection channel, the respective cords are already prepared for further mutually parallel distribution towards the cord inlay station and/or the extruder.

Preferably, the method further comprises the steps of:
providing a first cord clamp for keeping the group of cords threaded in the collection direction through the plurality of collection channels of a first cord collector of the plurality of cord collectors. In other words, the first cord clamp can prevent that the cords collected in the first cord collector slip out of their respective collection channels in a direction opposite to the collection direction.

More preferably, the method further comprise the step of:
clamping the group of cords with the first cord clamp in a clamping position at a side of the first cord collector facing downstream in the collection direction. Hence, the first cord clamp can effectively clamp a free length of the cords protruding out of the collection channels at the side of said clamping position and, by clamping said free lengths, prevent that the cords slip out of the collection channels in the opposite direction. In particular, the first cord clamp is designed so as to be larger, in cross section, than the collection channels, such that the first cord clamp, once fixates on the group of cords in the clamping position, cannot pass through the collection channels in a direction opposite to the collection direction.

Most preferably, the first cord collector is freely movable along the cords of the group of cords relative to the first cord clamp upstream of said clamping position with respect to the collection direction. Hence, the first cord collector can be spaced apart from the first cord clamp to expose a length of the group of cords in between that can be manipulated, for example for the purpose of guiding the cords through the extruder inserts.

In a further embodiment the first cord clamp is provided separately from the first cord collector, wherein the method further comprises the step of:
manipulating a length of the cords of the group of cords between the first cord collector and the first cord clamp by changing the relative position between the first cord collector and the first cord clamp. By providing the first cord clamp separately from the first cord collector, the first cord clamp can have considerable freedom of movement. For example, the first cord clamp may be held in one hand while the first cord collector is held in the other, in order to freely manipulate the length of the group of cords in between relative to parts of the tire building creel, the cord inlay station and/or the extruder.

In a further embodiment the method further comprises the step of:
transferring the first cord clamp and the first cord collector together from the tire building creel towards the cord inlay station. Hence, first cord clamp and the first cord collector can be transferred in a single action, thereby saving time.

In a further embodiment the method further comprises the step of:
releasing the group of cords from the first cord clamp at the cord inlay station. In this way, each cord of the group of cords can be guided separately through the cord inlay station. The cords may be released one by one, for example by briefly releasing the first cord clamp to allow manual removal of one of the cords and then clamping the 20 remaining cords again. By releasing the cords one by one, it can be prevented that the free ends of the cords get entangled. Preferably, the length of the cords between the first cord clamp and the first cord collector is sufficient to prevent that cords that are released from the first cord clamp immediately slip out of the first cord collector as well.

In a further embodiment the method further comprises the step of:
providing a further cord clamp for each further cord collector of the plurality of cord collectors. Hence, each group of cords can be clamped at their respective cord collectors.

In another embodiment the method further comprises the steps of:
holding one or more extruder inserts in an insert holder relative to a cord plane at the cord inlay station; and
extending the groups of cords in the collection direction from the plurality of cord collectors through the one or more extruder inserts at the insert holder. Hence, the cords can be prepared in the one or more extruder inserts while they remain collected in their respective cord collectors.

Preferably, the method further comprises the steps of:
transferring the one or more extruder inserts with the groups of cords extended therethrough from the cord inlay station to the extruder; and
transferring the plurality of cord collectors with the groups of cords collected therein from the cord inlay station to the extruder. The cord collectors can therefore remain in place during preparation and/or extrusion to ensure proper feeding of the cords into the extruder.

In another embodiment the plurality of cord collectors are manually transferred from the tire building creel to the cord inlay station. As each cord collector can collect and hold a group of cords, the manual transfer of the cord collectors is considerably less labor intensive compared to the individual transfer of cords according to the prior art.

According to a second aspect, the invention provides a cord organizer for organizing cords between a tire building creel and an extruder, wherein the cord organizer comprises a cord inlay station positionable between the tire building creel and the extruder for preparing the cords for insertion into the extruder, wherein the cord organizer is further provided with a plurality of cord collectors that are separable from the cord inlay station for collecting groups of the cords at the tire building creel and for transferring the groups of cords collected in said plurality of cord collectors from the tire building creel towards the cord inlay station.

The cord organizer can be used for executing the steps of the method according to the first aspect of the invention and thus has the same technical advantages, which will not be repeated hereafter.

In a preferred embodiment the cord organizer comprises a collector frame for receiving the plurality of cord collectors at the cord inlay station.

More preferably, the collector frame is configured for stacking at least two cord collectors of the plurality of cord collectors in a stacking direction perpendicular to a cord plane and/or for juxtaposing at least two cord collectors of the plurality of cord collectors in a lateral direction parallel to the cord plane.

In a further embodiment the collector frame is separable from the cord inlay station with the plurality of cord collectors received therein for transfer of said collector frame to a collector section at the extruder. The collector frame may thus be positioned at the cord inlay station during preparation of cords and may subsequently be transferred to the extruder to ensure proper feeding of the cords into the extruder during the extrusion process.

Preferably, the collector frame is provided with a handle. The handle allows for manual separation of the collector frame from the cord inlay station and for manual transfer of said collector frame to the extruder.

In a further embodiment each cord collector of the plurality of cord collectors comprises a collector body and a plurality of collection channels extending in a collection direction through said collector body for threading each cord of a respective group of cords through a different collection channel of the plurality of collection channels in the collection direction.

Preferably, the plurality of collection channels extend mutually parallel. Hence, the cords can be prepared for mutually parallel insertion into the extruder in a cord plane.

Additionally or alternatively, each collection channel of the plurality of collection channels comprises a funnel section at a side of the collector body facing upstream with respect to the collection direction and tapering in the collection direction. The funnel section can guide the cords into the respective collection channels, even when said cords approach said collection channels imprecisely or in a misaligned manner.

In another embodiment, for each collector body, the plurality of collection channels comprises at least ten collection channels, preferably at least twenty collection channels. Hence, a large number of cords can be collected in each cord collector and the cord collectors together can supply an even larger number of cords to the cord inlay station.

In another embodiment the plurality of collection channels are distributed across the collector body in a channel array having at least two rows and two columns. The cords can be thus be spaced apart in the plane of said channel array to be fed in a mutually parallel manner to the cord inlay station and/or the extruder. In particular, the channel array extends perpendicular to the collection direction.

In another embodiment the cord organizer further comprises a first cord clamp for keeping the group of cords threaded in the collection direction through the plurality of collection channels of a first cord collector of the plurality of cord collectors. In particular, the first cord clamp can effectively prevent that the cords slip out of the plurality of collection channels in a direction opposite to the collection direction. The first cord clamp may be integrated with the first cord collector, in which case the first cord clamp adds a clamping functionality to the first cord collector. Alternatively, the first cord clamp can be provided separately from the first cord collector. It is noted that the first cord clamp may be applied independently of the cord organizer, i.e. the first cord clamp can be made the subject of a divisional application as a separate tool for use in a tire building creel or the aforementioned cord organizer.

Additionally or alternatively, the first cord clamp comprises a handle. The handle allows for manual transfer of said first cord clamp between the tire building creel and the cord inlay station.

In a further embodiment the cord organizer comprises a further cord clamp for each further cord collector of the plurality of cord collectors.

In another embodiment the plurality of cords collectors are identical. Each cord collector can therefore be used in any position in the tire building creel, the cord inlay station and/or the extruder.

In another embodiment, that can also be applied independently of the plurality of cord collectors, the cord inlay station further comprises one or more cord magnets for temporarily retaining the cords in a cord plane, wherein the one or more cord magnets are movable between an active position at a first distance to the cord plane and an inactive position at a second distance to the cord plane, greater than the first distance. In the active position, the one or more cord magnets can temporarily retain the cords to prevent that the cords shift relative to the cord inlay station during preparation of said cords, in particular when said cords have already been released from the aforementioned cord clamps. In the inactive position, the one or more magnets are spaced apart from the cords sufficiently so as to not interfere with the preparation, manipulation and/or feeding of the cords in the cord plane.

In another embodiment the cord inlay station further comprises a clamp holder for temporarily holding the first cord clamp or the group of cords associated with said first cord clamp. The first cord clamp can temporarily be ‘parked’ while other operations are carried out at the cord inlay station. In case of multiple cord clamps, some of the cord clamps may be parked while others are held in position near the cord plane to release the cords for preparation in the cord inlay station. In this way, the cord inlay platform can be kept free from cord clamps or groups associated therewith, which are not actively being used in the process of organizing the cords.

In another embodiment the cord inlay station comprises an insert holder for holding one or more extruder inserts relative to a cord plane and a collector holder for holding a collector frame for receiving the plurality of cord collectors relative to the insert holder. Hence, the cord collectors can be held relative to the insert holder to extend the cords collected in said cord collectors towards the extruder inserts held in said insert holder.

In another embodiment, that can also be applied independently of the plurality of cord collectors, the cord organizer comprises a cord fault detector for detecting faults in the cords between the tire building creel and the extruder. Irregularities in the cords, such as broken filaments, may roll up or strip up against the extruder inserts and may cause serious damage to said extruder inserts, when not detected at an early stage. The cord fault detector can provide an early detection of such cord faults and stop the extrusion process before the cord faults cause serious damage to the extruder inserts.

More preferably, the cord fault detector comprises a cord fault catcher with a plurality of catch channels for threading each cord of the groups of cords through a different catch channel of the plurality of catch channels and one or more catch sensor for detecting displacement of the cord fault catcher in a cord direction as a result of a faulty cord getting stuck in one catch channel of the plurality of catch channels. Cords with broken filaments may fail to pass through the catch channels and subsequently start to strip up or roll up against said cord fault catcher, thereby exerting a force onto said cord fault catcher in the cord direction as the cords are fed further in said cord direction. The cord fault detector may be particularly useful for detecting displacement of the cord fault catcher as a result of said force.

More preferably, the cord inlay station further comprises a catcher holder for holding the cord fault catcher with the plurality of catch channels extending in a cord plane in-line with the cord direction. With the cord fault catcher extending in said cord plane, the cords can be conveniently threaded through the respective catch channels during the preparation of said cords in the cord plane.

Most preferably, the cord inlay station comprises an insert holder for holding one or more extruder inserts relative to the cord plane, wherein the cord fault catcher is separable from the catcher holder with the cords threaded through the catch channels for transfer of said cord fault catcher together with the one or more extruder inserts to the extruder. Once, the cord fault catcher is placed in the extruder, the extrusion process can be initiated with the cord fault catcher in a position upstream of the extruder inserts.

In another embodiment, that can also be applied independently of the plurality of cord collectors, the cord organizer comprises a guide roll with a roll axis extending in an axial direction and with a plurality of circumferential grooves extending about said roll axis for receiving the cords, wherein the cord organizer is further provided with a retainer positionable in a retainer position in which the retainer extends across the plurality of circumferential grooves in the axial direction. The retainer can prevent that the cords, once guided through the respective circumferential grooves, jump out of their respective circumferential grooves. In other words, the retainer ensures that the cords remain in place in their respective circumferential grooves.

Preferably, the cord organizer comprises a guide frame for holding the guide roller and one or more retainer magnets for magnetically retaining the retainer in the retainer position. The retainer can thus be manually placed in and manually removed from the retainer position without the use of tools.

Additionally or alternatively, the guide roll has a radial plane that coincides with the roll axis, wherein the retainer, in the retainer position, has a retainer edge that extends in said radial plane and a retainer surface that extends only at one side of said radial plane. The retainer position can be chosen such that said one side of the radial plane and/or the retainer surface is located downstream of the radial plane with respect to a feeding direction in which the cords are fed through the circumferential grooves. In this way, the retainer edge can effectively hold the cords in their respective circumferential grooves in a radial direction perpendicular to the roll axis, whereas the retainer surface opens up with respect to the circumferential grooves at said one side of the radial plane to prevent that the cords get stuck or pinched between the guide roll and the retainer surface in the feeding direction. In other words, the retainer surface is not in a position where it converges towards the guide roll.

Preferably, the retainer surface extends perpendicular to the radial plane. Hence, the retainer surface can be tangent to the guide roll at the radial plane.

In another embodiment, that can also be applied independently of the plurality of cord collectors, the cord inlay station is mobile. Hence, the cord inlay station may be moved into position between the tire building creel and the extruder when the cords are prepared for insertion into the extruder and it may subsequently be moved out of said position when the preparation has been completed. The cord inlay station may for example be put on wheels, more in particular castor wheels.

Preferably, the cord inlay station comprises a coupling member for coupling and/or aligning the cord inlay station with the tire building creel. In this way, the position of the cord inlay station can be linked to that of the tire building creel. In particular, when the tire building creel is moved, the cord inlay station may move together with said tire building creel, for example in a lateral direction perpendicular to the collection direction and/or the cord direction.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1-7 show side views of a tire building creel, an extruder and a cord organizer according to the invention, during the steps of a method for organizing cords between said tire building creel and said extruder;

FIG. 8 shows an isometric view of the cord organizer and a part of the tire building creel according to FIG. 1;

FIG. 9 shows a view of a first cord collector and a first cord clamp for use in the cord organizer according to FIG. 8;

FIG. 10 shows a cross section of the first cord collector and the first cord clamp according to the line X-X in FIG. 8;

FIG. 11 shows an exploded view of a cord inlay station of the cord organizer according to FIG. 8;

FIG. 12 shows a cross section of the cord inlay station according to the line XII-XII in FIG. 8;

FIG. 13 shows a cross section of the cord inlay station of FIG. 12 and the extruder of FIG. 1 during the transfer of extruder inserts, a cord fault catcher and a collector frame from the cord inlay station to the extruder;

FIG. 14 shows a cross section of the extruder with the extruder inserts, the cord fault catcher and the collector;

FIG. 15 shows a cross section of a guide roll and a retainer of the cord organizer according to the line XV-XV in FIG. 9;

FIG. 16 shows a side view of the guide roll and the retainer of FIG. 15;

FIGS. 17 and 18 show top views of the tire building creel according to FIG. 1, having two creel sections which are movable relative to each other; and

FIG. 19 shows an isometric view of a set of shafts for mounting creel bobbins in the tire building creel of FIG. 1; and

FIG. 20 shows a cross section of the set of shafts according to the line XX-XX in FIG. 19, with creel bobbins mounted thereon.

### DETAILED DESCRIPTION OF THE INVENTION

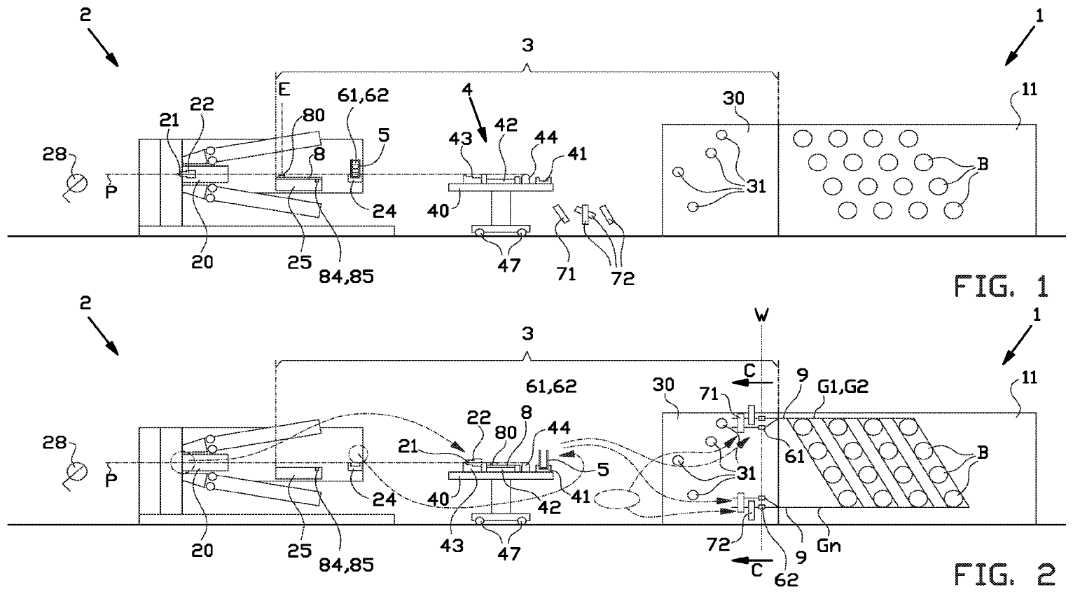

FIG. 1 shows a tire component manufacturing line according to an exemplary embodiment of the invention for manufacturing wire or cord-reinforced tire components, such as breaker plies. The tire components are used for building a green or unvulcanized tire.

The tire component manufacturing line comprises a tire building creel 1 for supplying wires or cords 9, an extruder 2 for embedding said cords 9 in an extrudate, in particular a layer of elastomeric material or rubber and a cord organizer 3 between the tire building creel 1 and the extruder 2 for organizing the cords 9.

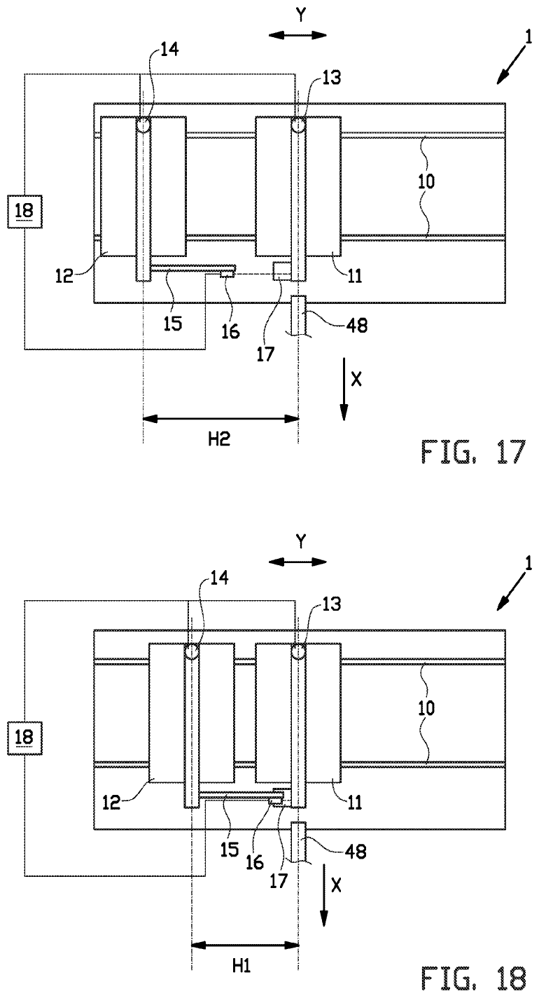

As shown in FIGS. 17 and 18, the tire building creel 1 comprises a first creel section 11 and a second creel section 12, each holding its own set of creel bobbins B. Each creel bobbin B stores a length of cord 9. The creel sections 11, 12 are movable along a creel guide 10 to be alternately aligned with the extruder 2 in a creel position, in a manner that will be described in more detail later in the description. In the side view of FIG. 1, only the first creel section 11 is shown.

As shown in FIG. 1, the extruder 2 comprises an extruder head 20 for receiving extruder tools or extruder inserts, in this example a die 21 and a cord guide 22. The die 21 has a die opening (not shown) that defines the cross sectional shape of the extrudate when it leaves the extruder 2. The cord guide 22 comprises a plurality of cord channels to feed the cords 9 in a mutually parallel orientation in a common cord plane P into the die 21 where said cords 9 are embedded in the extrudate.

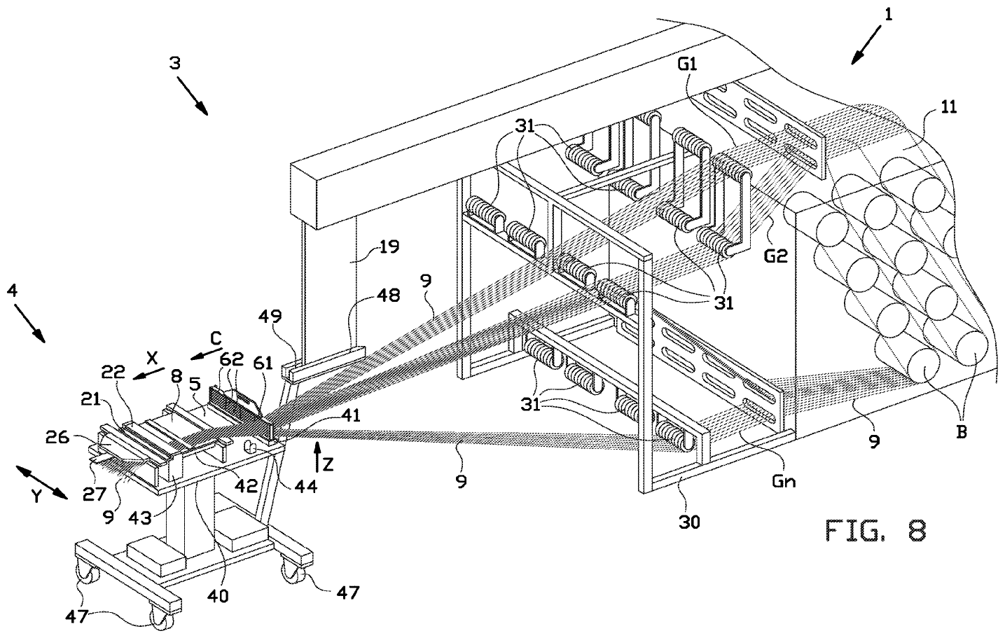

As shown in FIG. 8, the cord organizer 3 comprises a cord inlay station 4 that is positionable or positioned between the tire building creel 1 and the extruder 2. In this example, the cord inlay station 4 is freely positionable, movable or mobile with respect to the tire building creel 1 and the extruder 2. In particular, the cord inlay station 4 is provided on or with wheels 47, more in particular castor wheels for rolling the cord inlay station 4 over the factory floor. The cord inlay station 4 is further provided with a coupling member 48 for coupling the cord inlay station 4 to one of the creel sections 11, 12 of the tire building creel 1. When coupled, the cord inlay station 4 is configured to move together with or to be towed by the creel section 11, 12 to which it is coupled. In this example, the coupling member 48 includes an alignment element 49 for aligning with a complementary towing element 19 of the respective creel section 11, 12. In this example, the alignment element 49 is an alignment slot and the towing element 19 is a towing plate for insertion into said alignment slot.

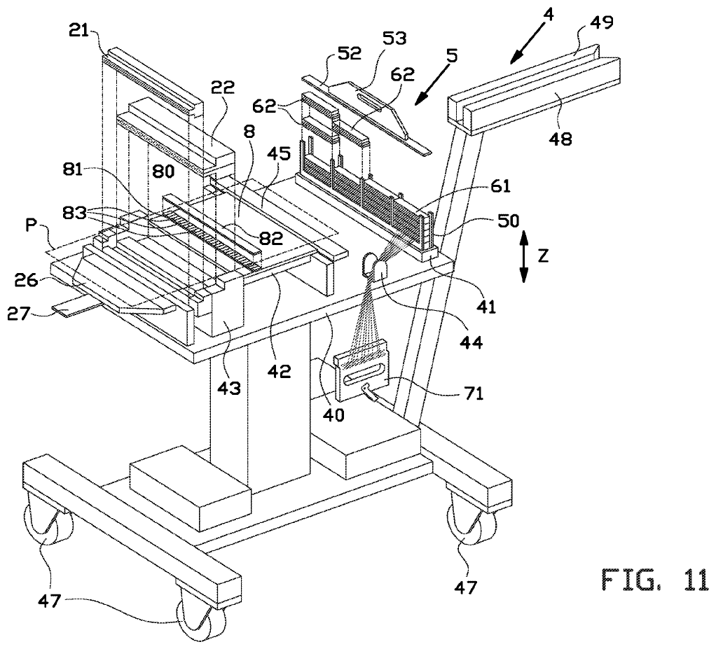

As shown in more detail in FIG. 11, the cord inlay station 4 is arranged, adapted or configured for preparing the cords 9 for insertion into the extruder 2. More specifically, the cord inlay station 4 is configured for preparing the cords 9 for mutually parallel insertion in a cord direction X and/or in the cord plane P into the extruder 2. For this purpose, the cord inlay station 4 has a cord inlay platform 40, preferably adjustable in height, for supporting the cords 9 at an ergonomic height for a human operator to manipulate the cords 9.

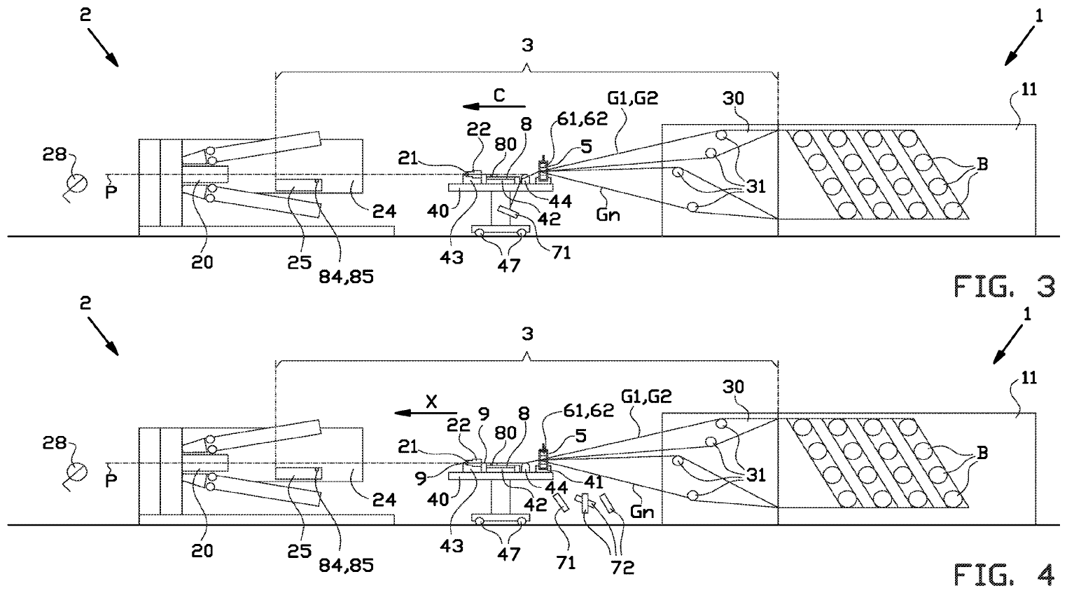

The cord organizer 3 is further provided with a plurality of cord collectors 61, 62 for collecting groups G1, G2, . . . , Gn of the cords 9 at the tire building creel 1, as shown in FIG. 2. The groups G1, G2, . . . , Gn of cords 9 collected in said cord collectors 61, 62 can subsequently be transferred from the tire building creel 1 towards the cord inlay station 4, as shown in FIG. 3, and/or from the cord inlay station 4 to the extruder 2, as shown in FIG. 7. In this way, the groups G1, G2, . . . , Gn of cords 9 can be collected in a decentralized manner, compared to the one-by-one collection and routing of the cords to a single, centralized cord collector according to the prior art.

The cord collectors 61, 62 are individually and/or independently mountable to and separable from the tire building creel 1, the cord inlay station 4 and/or the extruder 2. In particular, the cord collectors 61, 62 are designed in terms of weight, size and/or ergonomics to be carried and/or transferred manually.

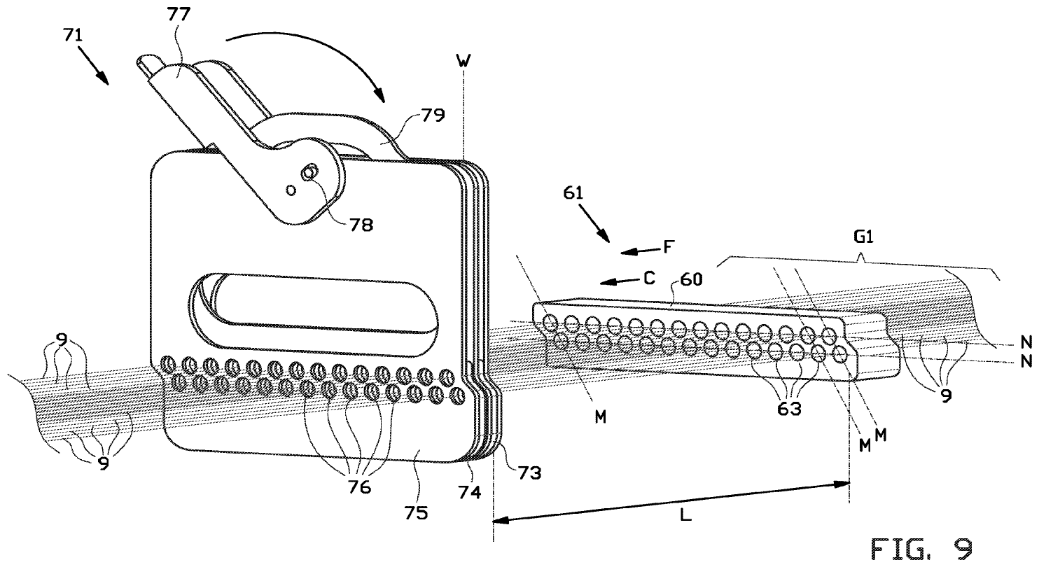

FIG. 9 shows a first cord collector 61 of the plurality of cord collectors 61, 62 in more detail. The first cord collector 61 is representative for the further cord collectors 62 of the plurality of cord collectors 61, 62. In fact, the cord collectors 61, 62 may be identical.

As shown in FIG. 9, the first cord collector 61 comprises a collector body 60 and a plurality of collection channels 63 extending in a collection direction C through said collector body 60 for threading each cord 9 of a first group G1 of cords 9 through a different collection channel 63 of the plurality of collection channels 63 in the collection direction C. In this example, the collection channels 63 extend mutually parallel. In this example, the first cord collector 61 has twenty-eight collection channels 63 distributed over or across the collector body 60 in a channel array of two rows M and fourteen columns N. It will however be understood by one skilled in the art that any other number of collection channels 63, rows M or columns N is within the scope of the present invention.

Each collection channel 63 of the plurality of collection channels 63 comprises a funnel section 64 at a side of the collector body 60 facing upstream with respect to the collection direction C. The funnel section 64 tapers in the collection direction C to facilitate easy insertion of the cords 9, even when the cords 9 are inserted imprecisely or when they are misaligned during insertion.

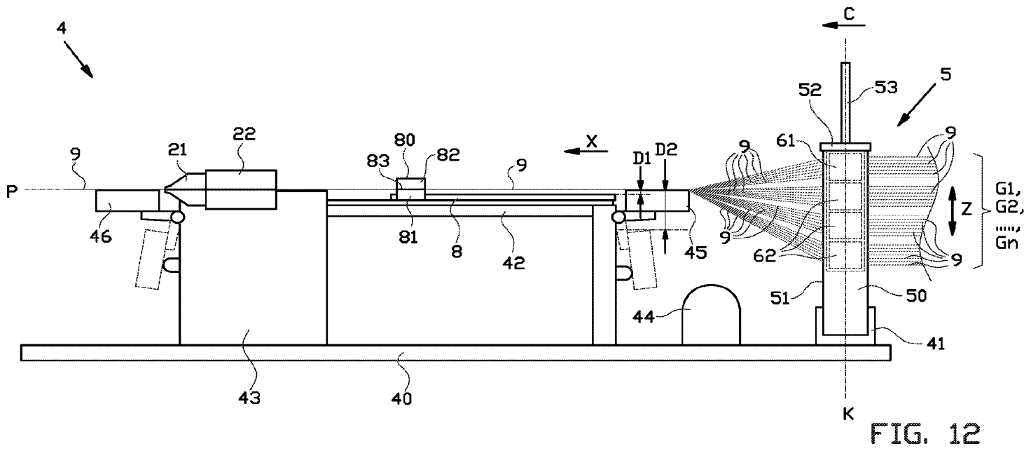

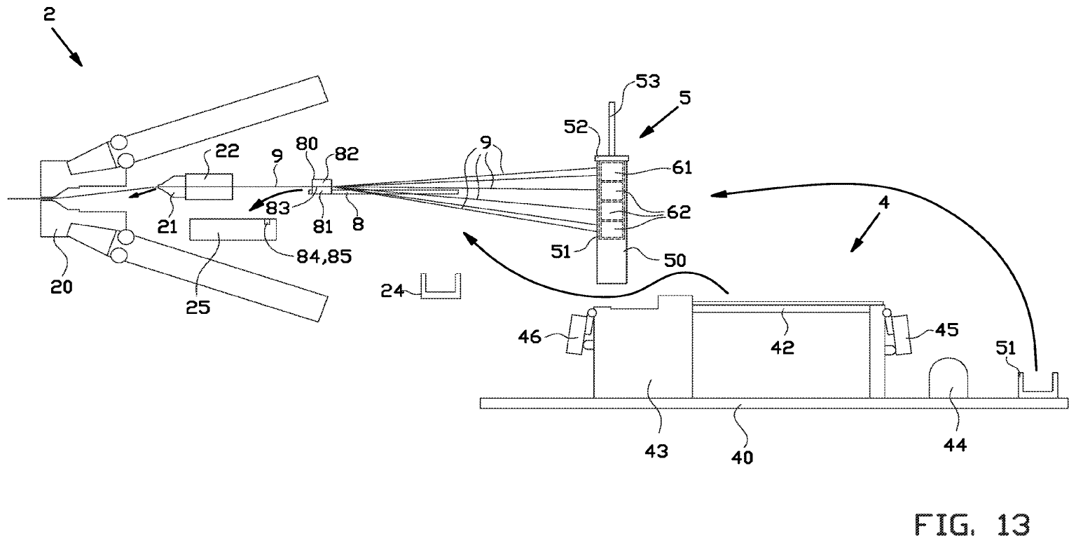

As shown in FIGS. 11 and 12, the cord inlay station 4 is provided with a collector holder 41 for holding or receiving the cord collectors 61, 62. In this example, the cord organizer 3 is provided with a collector frame 5 for receiving the cord collectors 61, 62 in the collector holder 41 at the cord inlay station 4. The collector frame 5 is mountable to and separable from the collector holder 41 at the cord inlay station 4.

As best seen in FIG. 11, the collector frame 5 comprises a receiving body 50 with a receiving slot 51 for receiving the cord collectors 61, 62. The receiving body 50 and/or the receiving slot 51 are dimensioned, shaped and/or configured for stacking four cord collectors 61, 62 of the plurality of cord collectors 61, 62 in a stacking direction Z perpendicular to the cord plane P and for juxtaposing four cord collectors 61, 62 of the plurality of cord collectors 61, 62 in a lateral direction Y parallel to the cord plane P. Hence, the cord collectors 61, 62 can be received in a collector matrix or a collector array, in this example a collector array of 4×4 cord collectors 61, 62, extending in a single collector plane K such that all of the cords 9 collected therein can be fed to or distributed within the cord inlay station 4 from said collector plane K.

The collector frame 5 further comprises a cover 52 for closing the receiving slot 51 and retaining the cord collectors 61, 62 in said receiving slot 51. The cover 52 and/or the receiving body 50 may optionally be provided with a handle 53 for manual transfer of said collector frame 5, with the cord collectors 61, 62 retained therein, from the cord inlay station 4 to the extruder 2.

As shown in FIG. 9, the cord organizer 3 may optionally be provided with a first cord clamp 71 for keeping the group G1 of cords 9 threaded in the collection direction C through the plurality of collection channels 63 of the first cord collector 61. In other words, the first cord clamp 71 prevents that the cords 9 slip out of the collection channels 63 in a direction opposite to the collection direction C.

In this example, the first cord clamp 71 is provided separately from the first cord collector 61. In other words, the first cord clamp 71 and the first cord collector 61 are not interconnected or connected directly. Hence, the first cord clamp 71 and the first cord collector 61 can be moved and/or positioned freely relative to each other. In particular, the first cord clamp 71 and the first cord collector 61 may be spaced apart in the collection direction C such that a length L of the cords 9 in between can be manipulated by moving one of the first cord clamp 71 and the first cord collector 61, or both. Alternatively, the first cord clamp 71 may be connected to or integrated with the first cord collector 61. For example, the first cord clamp 71 may be considered as a cord collector with integrated clamping functionality. In such an alternative scenario, the separate first cord collector 61 would not be required.

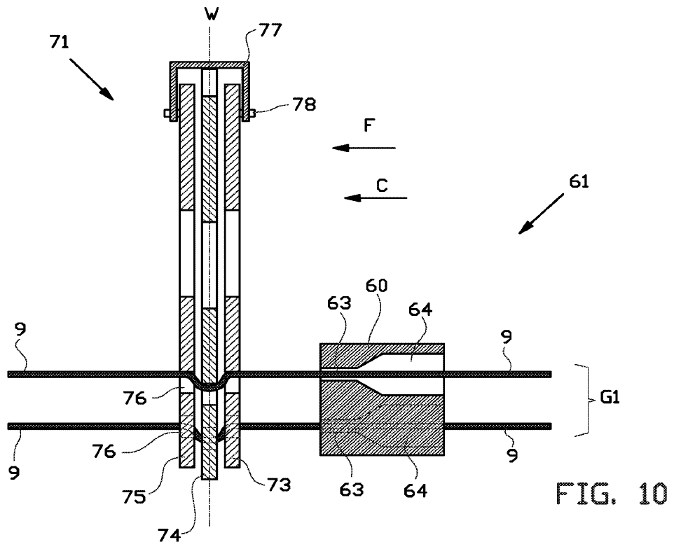

As best seen in FIG. 10, in this example, the first cord clamp 71 comprises a set of clamp plates 73, 74, 75, at least one of which is movable relative to the other clamp plates to pinch the cords 9 between the clamp plates 73-75, each with clamping apertures 76. The first cord clamp 71 is positioned in a clamping position W at a side of the first cord collector 61 downstream with respect to the collection direction C. Preferably, the clamping apertures 76 are equal in number to and aligned with the collection channels 63 in the collection direction C for facilitating easy threading of the cords 9 through both the collection channels 63 as well as the clamping apertures 76.

In this particular embodiment, the set of clamp plates 73-75 comprises a first clamp plate 73, a second clamp plate 74 and a third clamp plate 75. The second clamp plate 74 is interposed or sandwiched between the first clamp plate 73 and the third clamp plate 75 and is movable relative to said first clamp plate 73 and said third clamp plate 75 in a direction transverse or perpendicular to the collection direction C. In this example, as shown in FIG. 9, the first cord clamp 71 is provided with a clamping lever 77 that eccentrically supports the second clamp plate 74 relative to a lever axis 78. When the clamping lever 77 is moved, the second clamp plate 74 is moved relative to the other clamp plates 73, 75 and the clamping apertures 76 of the second clamp plate 74 are brought out of alignment with the clamping apertures 76 of the other clamp plates 73, 75, thereby clamping and/or pinching the cords 9.

It will be understood by one skilled in that art that various other clamping solutions may be envisioned, including but not limited to clamping jaws, magnets or the like.

As shown in FIG. 9, in this example, the first cord clamp 71 is provided with a handle 79 to enable manual transfer of said first cord clamp 71 from the tire building creel 1 towards the cord inlay station 4.

As schematically shown in FIG. 2, the cord organizer 3 comprises a further cord clamp 72 for each further cord collector 62 of the plurality of cord collectors 61, 62. Said further cord clamp 72 is identical to the first cord clamp 71 described above.

As shown in FIGS. 11 and 12, the cord inlay station 4 is further provided with a catcher holder 42 for holding a cord fault detector 8 during preparation of the cords 9 for insertion into the extruder 2. The cord fault detector 8 is arranged to be placed in a fault detection position E upstream of the cord guide 22 in the extruder 2, as shown in FIG. 14, for detecting faults F in the cords 9 between the tire building creel 1 and the extruder 2.

As best seen in FIG. 11, the cord fault detector 8 comprises a cord fault catcher 80 with a plurality of catch channels 83 for threading each cord 9 of the groups G1, G2, . . . , Gn of cords 9 through a different catch channel 83 of the plurality of catch channels 83. In this example, the cord fault catcher 80 has a construction similar to the cord guide 22 in the sense that it comprises a catch body 81 that at least partially defines the catch channels 83 and a cover 82 for closing or completing the catch channels 83. Hence, the cords 9 can pass through the catch channels 83 in the same way or substantially the same way as they would ultimately pass through the cord channels of the cord guide 22. Hence, any faults in the cords that would cause a problem at the cord guide 22, will already be caught by the cord fault catcher 80, thereby preventing damage to the cord guide 22.

As shown in FIG. 14, the cord fault detector 8 further comprises, at the catcher section 25, one or more catch sensors 84, 85 for detecting displacement of the cord fault catcher 80 in the cord direction X as a result of a fault F in the cords 9 getting stuck in one of the catch channels 83. The cord fault catcher 80 may be held in place at the catcher section 25 by a suitable catch retainer 86, for example a magnet or a spring. Once the force that is exerted onto the cord fault catcher 80 in the cord direction X as a result of a faulty cord 9 getting stuck in one of the catch channels 83 exceeds the retaining force of the catch retainer 86, the cord fault catcher 80 may start its displacement in the cord direction X.

As shown in FIGS. 11 and 12, the cord inlay station 4 further comprises an insert holder 43 for holding the die 21 and the cord guide 22 relative to the cord plane P in a position downstream of the collector holder 41 and the catcher holder 42 in the cord direction X.

As best seen in FIG. 11, the cord inlay station 4 further comprises a clamp holder 44 for temporarily holding or parking one or more of the cord clamps 71, 72 or the groups G1, G2, . . . , Gn of cords 9 associated with said cord clamps 71, 72. In this way, the cord inlay platform 40 can be kept free from cord clamps 71, 72 or groups G1, G2, . . . , Gn associated therewith, which are not actively being used in the process of organizing the cords 9.

As shown in FIG. 12, the cord inlay station 4 further comprises a first cord magnet 45 and a second cord magnet 46 for temporarily retaining the cords 9 in the cord plane P. The cord magnets 45, 46 are movable between an active position, as shown in solid lines, extending in, parallel to or at a first distance D1 to the cord plane P, and an inactive position, as shown in dashed lines, at a second distance D2 to the cord plane P, greater than the first distance D1.

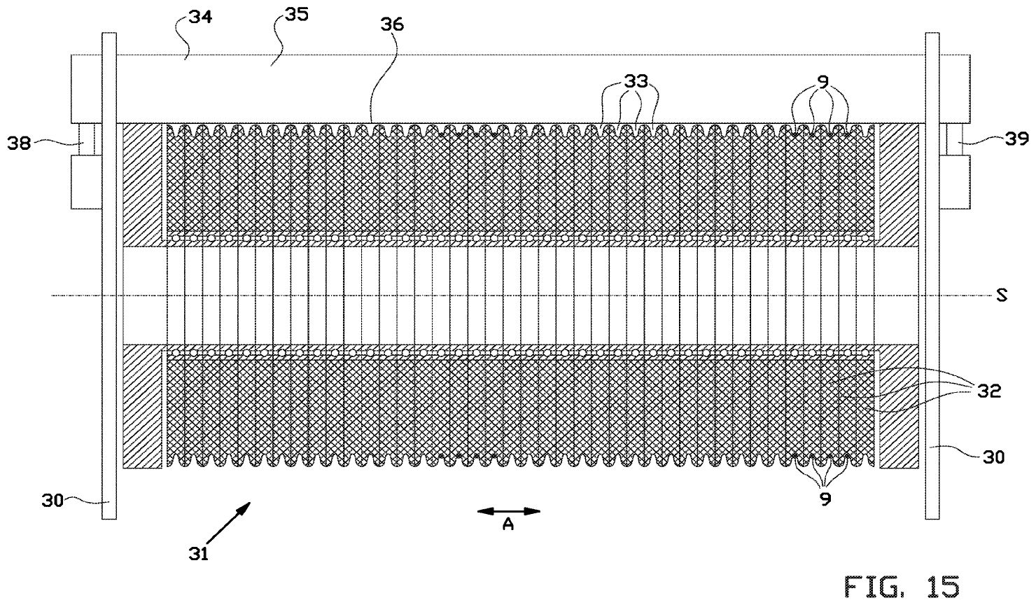

In this example, as best seen in FIG. 8, the cord organizer 3 further comprises a plurality of guide rolls 31 for guiding the cords 9 from the tire building creel 1 towards the cord inlay station 4 and a guide frame 30 for holding said plurality of guide rolls 31. As shown in FIG. 15, each guide roll 31 has a roll axis S extending in an axial direction A. Each guide roll 31 further comprises a plurality of discs 32 arranged side-by-side in the axial direction A so as to be individually rotatable about the roll axis S. Each disc 32 defines a circumferential groove 33 extending about said roll axis S for receiving a respective one of the cords 9 around at least a part of the circumference of the guide roll 31.

The cord organizer 3 is further provided with a retainer 34 that is positionable in a retainer position T, as shown in FIGS. 8 and 9, relative to a respective one of the guide rolls 31. The retainer 34 has a retainer body 35 that, in the retainer position T, extends over or across the plurality of circumferential grooves 33 of the respective guide roll 31 in the axial direction A. In this example, the retainer body 35 is shaped like a beam or a bar.

In the example as shown in FIG. 8, the organizer 3 is provided with retainer magnets 38, 39 for retaining the retainer 34 in the retainer position T relative to the respective guide roll 31. In this particular embodiment, the retainer magnets 38, 39 are provided on the guide frame 30 that holds the respective guide roll 31. More in particular, the guide frame 30 is provided with one retainer magnet 38, 39 on each side of the guide roll 31 in the axial direction A. The retainer body 35 comprises ferromagnetic material that can be magnetically attracted towards the retainer magnets 38, 39. It will be understood by one skilled in the art that other means for detachably fastening, fixating, clamping or retaining the retainer 34 in the retainer position T relative to the respective guide roll 31 may be provided, including but not limited to clamps, screws, bolts and the like.

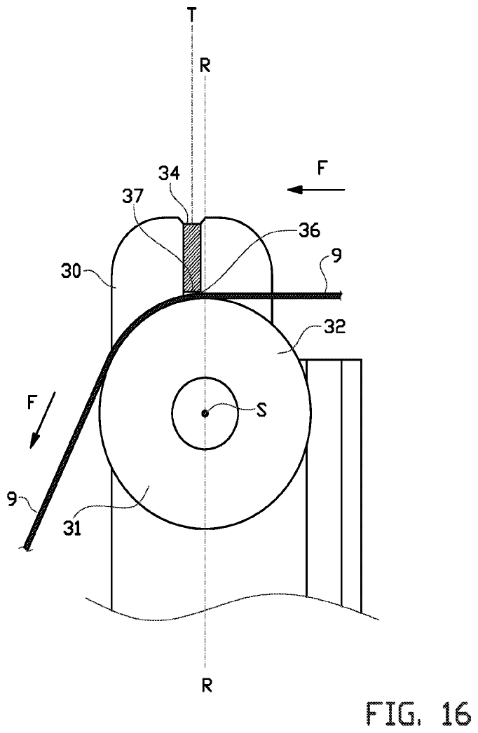

As shown in FIG. 16, the guide roll 31 has a radial plane R that coincides with the roll axis S. The retainer 34, in the retainer position T, has a retainer edge 36 that extends in said radial plane R, parallel to the axial direction A. The retaining body 35 further defines a retainer surface 37 that extends only at one side of said radial plane R. In particular the retainer surface 37 extends perpendicular to the radial plane R.

As shown in FIGS. 17 and 18, in this example, the first creel section 11 and the second creel section 12 are provided with a first creel drive 13 and a second creel drive 14, respectively, for individually and/or independently moving the respective creel sections 11, 12 along the creel guide 10. The independently movable creel sections 11, 12 have the technical advantage over their mutually fixed counterparts that, in the absence of any mechanical interconnection, they can be moved apart for maintenance, loading, unloading and/or reconfiguration instantly or immediately, without requiring mechanically unlocking any mechanical interconnections.

The tire building creel 1 further comprises a spacer 15, in particular a spacer bar, attached to the second creel section 12 and protruding towards the first creel section 11, to keep said second creel section 12 physically spaced apart from the first creel section 11 at a minimum distance H1. This may avoid hazardous situations to operators working in between the creel sections 11, 12 or damage to the creel sections 11, 12. The tire building creel 1 is also provided with a distance sensor 16, for example a laser, to measure the distance between the creel sections 11, 12. In this example, the distance sensor 16 is provided on the second creel section 12 as well. The creel drives 13, 14 and the distance sensor 16 are operationally, electronically and/or functionally connected to a control unit 18 which is configured to keep the distance between the creel sections 11, 12, as detected by the distance sensor 16, below a maximum distance H2.

The control unit 18 may further be configured, programmed or arranged for controlling the creel drives 13, 14 such that the creel sections 11, 12 remain at a constant or substantially constant distance between the minimum distance H1 and the maximum distance H2.

In this example, the first creel section 11 is provided with a docking 17 for physically receiving the distal end of the spacer 15 when the creel sections 11, 12 are at the minimum distance H1.

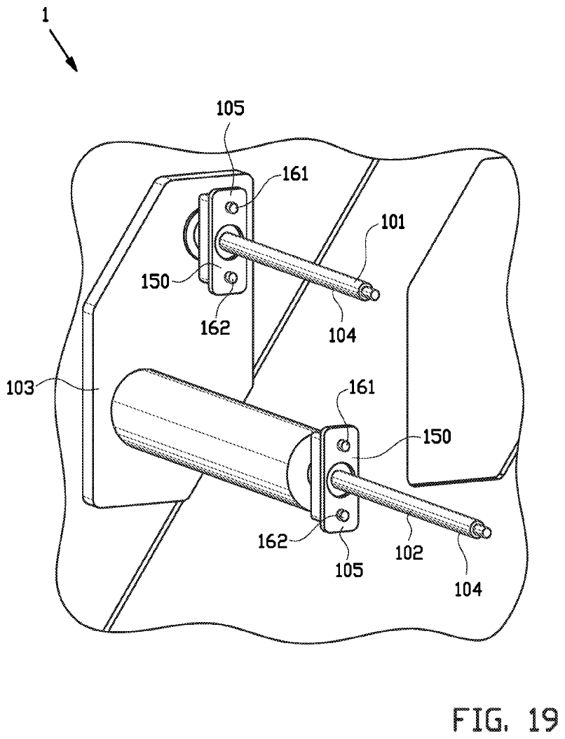

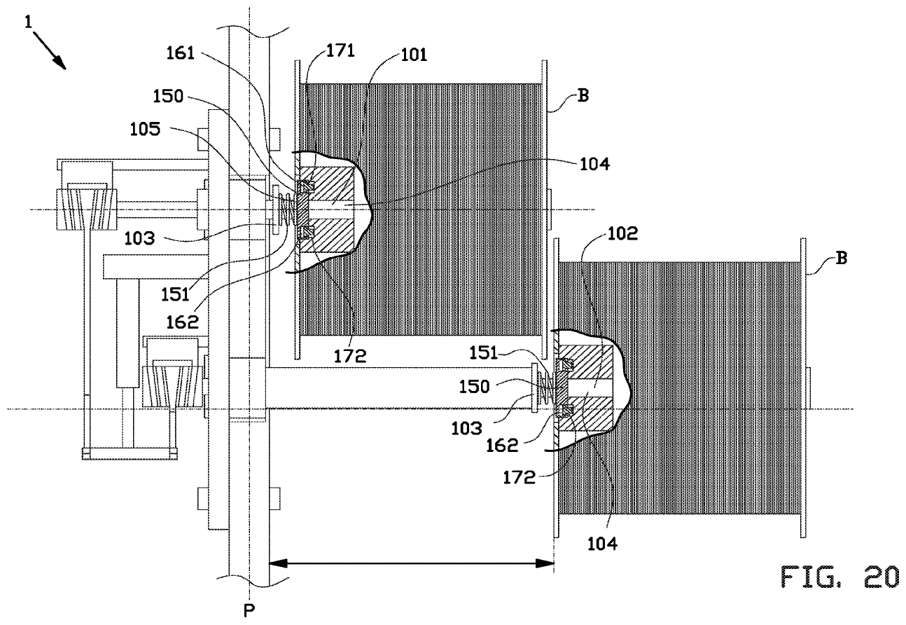

FIGS. 19 and 20 show a set of first shaft 101 and a second shaft 102 for mounting a pair of creel bobbins B to the creel sections 11, 12 of the tire building creel 1 of FIG. 1.

Each shaft 101, 102 comprises shaft base 103 and a shaft body 104 supported by and/or extending from said shaft base 103. In this example, the shaft body 104 of the second shaft 102 is longer or offset o in the axial direction to receive carry the respective creel bobbin B in a position alongside the creel bobbin B that is carried by the first shaft 101. Alternatively, the shaft bodies of all shafts 101, 102 may have the same length or may be identical to support all of the creel bobbins B in the same manner.

As shown in FIG. 19, each shaft 101, 102 is further provided with a shock absorber 105 for absorbing impacts or shocks in the axial direction as a result of the creel bobbins B being placed on or slid onto said shaft 101, 102 in said axial direction. As best seen in FIG. 20, the shock absorber 105 comprises an absorber body 150 for contacting the creel bobbin B as it is being placed on the respective shaft 101, 12 and a spring 151 that is arranged between the absorber body 150 and the shaft base 103 to at least partially absorb the impact, the shock or the kinetic energy of the creel bobbin B in the axial direction. The absorber body 150 is slidable along the respective shaft 101, 102 in the axial direction over a limited range. Preferably, the absorber body 150 is fixed in rotation to the respective shaft 101, 102, but allows for axial movement to absorb the impact. In other words, the absorber body 150 is configured to rotate together with the respective shaft 101, 102.

In this example, as shown in FIG. 20, the shock absorber 105 is further provided with one or more locking pins 161, 162, in this example two locking pins 161, 162, which are provided in, at or on the absorber body 150 and which are configured to engage with and/or snap into corresponding locking apertures 171, 172 in the creel bobbin B for fixing the creel bobbin B in rotation to the shock absorber 105, and indirectly via said absorber body 150 to the respective shaft 101, 102. When the locking pins 161, 162 and the respective locking apertures are misaligned during the initial placement of the creel bobbin B on the respective shaft 101, 102, they may be pushed into or recessed in the absorber body 150, until the locking pins 161, 162 and the respective locking apertures 171, 172 become aligned and the locking pins 161, 162 can automatically snap into the respective locking apertures 171, 172.

Preferably, the locking pins 161, 162 are magnetic or provided with magnets to magnetically snap into the creel bobbin B and retain the creel bobbin B to the absorber body 150. Therefore, the shafts 101, 102 can be arranged horizontally or substantially horizontally, while the magnetic attraction between the locking pins 161, 162 and the creel bobbins B prevent that said creel bobbins B slide off the respective shafts 101, 102.

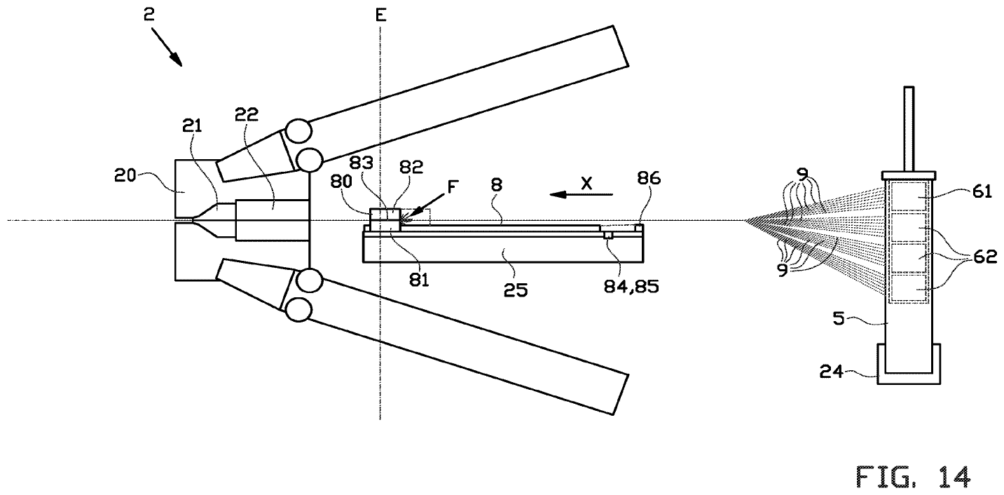

A method for organizing the cords 9 between the tire building creel 1 and the extruder 2 with the use of the aforementioned cord organizer 3 will now be briefly elucidated with reference to FIGS. 1-14.

FIG. 1 shows the situation at the end of a previous cycle of the method, with the die 21 and the cord guide 22 in the extruder head 20, the cord fault detector 8 in the catcher section 25, the collector frame 5 with the cord collectors 61, 62 received therein in the collector section 24, the cord clamps 71, 72 stored in a position near the cord inlay station 4 and the tire building creel 1 ready to feed new cords from the creel bobbins B or to receive new creel bobbins B with new lengths of the cords.

FIG. 2 shows the situation after the die 21 and the cord guide 22 have been removed from the extruder head and have been placed in the insert holder 43 at the cord inlay station 4. The cord fault detector 8 has been removed from the catcher section 25 and has been returned to the catcher holder 42 at the cord inlay station 4. The collector frame 5 has been removed from the collector section 24 and has been returned to the collector holder 41 at the cord inlay station 4. The cord collectors 61, 62 have been removed from the collector frame 5 and have been positioned at the output side of the tire building creel 1 to receive or collect the cords 9 in groups G1, G2, . . . , Gn. In this example, the cord clamps 71, 72 have been moved to their respective clamping positions W downstream of the cord collectors 61, 62 to clamp the cords 9 which are collected in the respective cord collectors 61, 62, in the manner as described before and as shown in FIGS. 9 and 10.

FIG. 3 shows the situation after the cord collectors 61, 62 and the cord clamps 71, 72 have been transferred from the tire building creel 1 towards the cord inlay station 4 while guiding the cords 9 collected therein along the respective guide rolls 31. The cord collectors 61, 62 are received in the collector frame 5 at the collector holder 41 and one or more of the cord clamps 71, 72 are temporarily parked in the clamp holder 44.

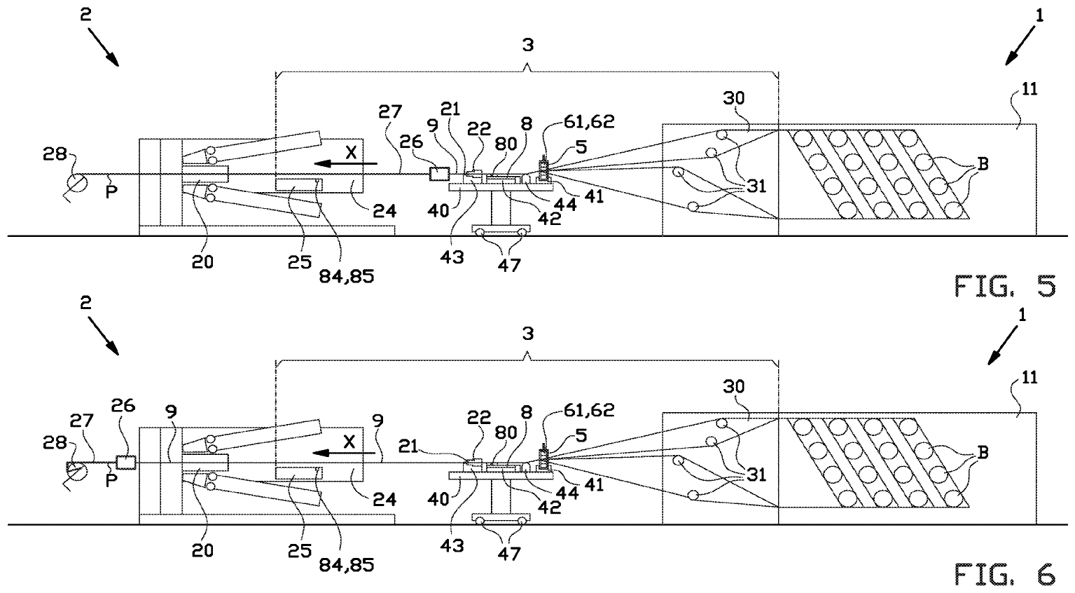

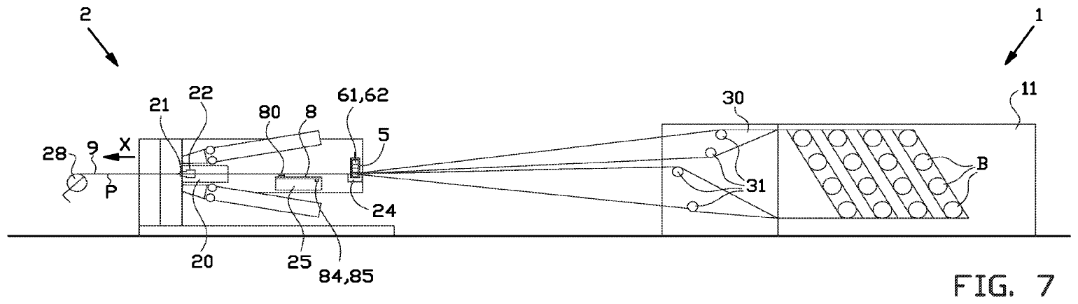

FIGS. 4 and 12 show the situation in which the cords 9 have been released from the cord clamps 71, 72 and have been extended through the cord fault catcher 8, the cord guide 22 and the die 21, as shown schematically for a limited number of groups G1, G2, . . . , Gn in FIG. 8.

FIG. 5 shows the situation in which a hook 26 is attached to leading ends of the cords 9 protruding from the die 21 in the cord direction X. The hook 26 is connected to a winch 28 via a pulling member 27, in particular a pulling strip, for pulling the hook 26 and the cords 9 attached thereto in the cord direction X towards, into and/or through the extruder 2.

FIG. 6 shows the situation in which the hook 26 and the cords 9 attached thereto has been pulled through extruder 2. Note that, in this example, the cords 9 have been extended through the collector frame 5 with the cord collectors 61, 62, the cord fault detector 8, the cord guide 22 and the die 21 in the cord direction X while these parts remain in place in their respective holders 41-43 on the cord-inlay station 4. Alternatively, the collector frame 5 with the cord collectors 61, 62, the cord fault detector 8, the cord guide 22 and the die 21 may be transferred to the extruder 2 together with the cords 9.

FIGS. 7 and 14 show the situation in which the cord guide 22 and the die 21 have been transferred from the insert holder 43 to the extruder head 20. The cord fault detector 8 has been transferred from the catcher holder 42 to the catcher section 25 with the cord fault catcher 80 positioned at the fault detection position E upstream of the extruder head 20 with respect to the cord direction X. The collector frame 5 with the cord collectors 61, 62 received therein is transferred to the collector section 24. The extruder 2 is now ready for extruding the extrudate while embedding the cords 9 in said extrudate.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 tire building creel
10 creel guide
11 first creel section
12 second creel section
13 first creel drive
14 second creel drive
15 spacer
16 distance sensor
17 docking
18 control unit
19 towing element
2 extruder
20 extruder head
21 die
22 cord guide
23 insert section
24 collector section
catcher section
26 hook
27 pulling member
28 winch
3 cord organizer
30 guide frame
31 guide roll
32 disc
33 circumferential groove
34 retainer
35 retainer body
36 retainer edge
37 retainer surface
38 first retainer magnet
39 second retainer magnet
4 cord inlay station
40 cord inlay platform
41 collector holder
42 catcher holder
43 insert holder
44 clamp holder
45 first cord magnet
46 second cord magnet
47 wheel
48 coupling member
49 alignment element
5 collector frame
50 receiving body
51 receiving slot
52 cover
53 handle
60 collector body
61 first cord collector
62 further cord collector
63 collection channel
64 funnel section
71 first cord clamp
72 further cord clamp
73 first clamp plate
74 second clamp plate
75 third clamp plate
76 clamping aperture
77 clamping lever
78 lever axis
79 handle
8 cord fault detector
80 cord fault catcher
81 catch body
82 catch cover
83 catch channel
84 first catch sensor
85 second catch sensor
86 catch retainer
9 cord
101 first bobbin shaft
102 second bobbin shaft
103 shaft base
104 shaft body
105 shock absorber
150 absorber body
151 spring
161 first locking pin
162 second locking pin
171 first locking aperture
172 second locking aperture
A axial direction
B creel bobbin
C collection direction
D1 first distance
D2 second distance
E cord fault detection position
F cord fault
G1 first group of cords
G2 second group of cords
Gn n-th group of cords
H1 minimum distance
H2 maximum distance
K collector plane
L length
M row
N column
P cord plane
R radial plane
S roll axis
T retainer position
V feeding direction
W clamping position
X cord direction
Y lateral direction
Z stacking direction

1. A method for organizing cords between a tire building creel and an extruder, wherein the method comprises the steps of:
providing a cord inlay station between the tire building creel and the extruder for preparing the cords for insertion into the extruder;
collecting groups of the cords in a plurality of cord collectors at the tire building creel; and
transferring said plurality of cords collectors with the groups of cords collected therein from the tire building creel towards the cord inlay station.

2. The method according to claim 1, wherein the method further comprises the step of:
receiving the plurality of cord collectors in a collector frame.

3. The method according to claim 2, wherein the method further comprises the steps of:
preparing the cords in the cord inlay station for mutually parallel insertion in a common cord plane into the extruder; and
stacking at least two cord collectors of the plurality of cord collectors in the collector frame in a stacking direction perpendicular to the cord plane.

4. The method according to claim 2, wherein the method further comprises the steps of:
preparing the cords in the cord inlay station for mutually parallel insertion in a common cord plane into the extruder; and
juxtaposing at least two cord collectors of the plurality of cord collectors in the collector frame in a lateral direction parallel to the cord plane.

5. The method according to claim 1, wherein each cord collector of the plurality of cord collectors comprises a collector body and a plurality of collection channels extending in a collection direction through said collector body, wherein the method further comprises the step of:
for each cord collector of the plurality of cord collectors, threading each cord of a respective group of cords through a different collection channel of the plurality of collection channels in the collection direction.

6. The method according to claim 5, wherein the method further comprises the steps of:
providing a first cord clamp for keeping the group of cords threaded in the collection direction through the plurality of collection channels of a first cord collector of the plurality of cord collectors.

7. The method according to claim 6, wherein the method further comprise the step of:
clamping the group of cords with the first cord clamp in a clamping position at a side of the first cord collector facing downstream in the collection direction.

8. The method according to claim 7, wherein the first cord collector is freely movable along the cords of the group of cords relative to the first cord clamp upstream of said clamping position with respect to the collection direction.

9. The method according to claim 5, wherein the first cord clamp is provided separately from the first cord collector, wherein the method further comprises the step of:
manipulating a length of the cords of the group of cords between the first cord collector and the first cord clamp by changing the relative position between the first cord collector and the first cord clamp.

10. The method according to claim 5, wherein the method further comprises the step of:
transferring the first cord clamp and the first cord collector together from the tire building creel towards the cord inlay station.

11. The method according to claim 5, wherein the method further comprises the step of:
releasing the group of cords from the first cord clamp at the cord inlay station.

12. The method according to claim 5, wherein the method further comprises the step of:
providing a further cord clamp for each further cord collector of the plurality of cord collectors.

13. The method according to claim 1, wherein the method further comprises the steps of:
preparing the cords in the cord inlay station for mutually parallel insertion in a common cord plane into the extruder;
holding one or more extruder inserts in an insert holder relative to the cord plane at the cord inlay station; and
extending the groups of cords in the collection direction from the plurality of cord collectors through the one or more extruder inserts at the insert holder.

14. The method according to claim 13, wherein the method further comprises the steps of:
transferring the one or more extruder inserts with the groups of cords extended therethrough from the cord inlay station to the extruder; and
transferring the plurality of cord collectors with the groups of cords collected therein from the cord inlay station to the extruder.

15. The method according to claim 1, wherein the plurality of cord collectors are manually transferred from the tire building creel to the cord inlay station.

16. A cord organizer for organizing cords between a tire building creel and an extruder, wherein the cord organizer comprises a cord inlay station positionable between the tire building creel and the extruder for preparing the cords for insertion into the extruder, wherein the cord organizer is further provided with a plurality of cord collectors that are separable from the cord inlay station for collecting groups of the cords at the tire building creel and for transferring the groups of cords collected in said plurality of cord collectors from the tire building creel towards the cord inlay station.

17. The cord organizer according to claim 16, wherein the cord organizer comprises a collector frame for receiving the plurality of cord collectors at the cord inlay station.

18. The cord organizer according to claim 17, wherein the collector frame is configured for stacking at least two cord collectors of the plurality of cord collectors in a stacking direction perpendicular to a cord plane.

19. The cord organizer according to claim 17, wherein the collector frame is configured for juxtaposing at least two cord collectors of the plurality of cord collectors in a lateral direction parallel to a cord plane.

20. The cord organizer according to claim 17, wherein the collector frame is separable from the cord inlay station with the plurality of cord collectors received therein for transfer of said collector frame to a collector section at the extruder.

21. The cord organizer according to claim 20, wherein the collector frame is provided with a handle.

22. The cord organizer according to claim 16, wherein each cord collector of the plurality of cord collectors comprises a collector body and a plurality of collection channels extending in a collection direction through said collector body for threading each cord of a respective group of cords through a different collection channel of the plurality of collection channels in the collection direction.

23. The cord organizer according to claim 22, wherein the plurality of collection channels extend mutually parallel.

24. The cord organizer according to claim 22, wherein each collection channel of the plurality of collection channels comprises a funnel section at a side of the collector body facing upstream with respect to the collection direction and tapering in the collection direction.

25. The cord organizer according to claim 22, wherein, for each collector body, the plurality of collection channels comprises at least ten collection channels, preferably at least twenty collection channels.

26. The cord organizer according to claim 22, wherein the plurality of collection channels are distributed across the collector body in a channel array having at least two rows and two columns.

27. The cord organizer according to claim 22, wherein the cord organizer further comprises a first cord clamp for keeping the group of cords threaded in the collection direction through the plurality of collection channels of a first cord collector of the plurality of cord collectors.

28. The cord organizer according to claim 27, wherein the first cord clamp is provided separately from the first cord collector.

29. The cord organizer according to claim 27, wherein the first cord clamp comprises a handle.

30. The cord organizer according to claim 27, wherein the cord organizer comprises a further cord clamp for each further cord collector of the plurality of cord collectors.

31. The cord organizer according to claim 16, wherein the plurality of cord collectors are identical.

32. The cord organizer according to claim 16, wherein the cord inlay station further comprises one or more cord magnets for temporarily retaining the cords in a cord plane, wherein the one or more cord magnets are movable between an active position at a first distance to the cord plane and an inactive position at a second distance to the cord plane, greater than the first distance.

33. The cord organizer according to claim 16, wherein the cord inlay station further comprises a clamp holder for temporarily holding the first cord clamp or the group of cords associated with said first cord clamp.

34. The cord organizer according to claim 16, wherein the cord inlay station comprises an insert holder for holding one or more extruder inserts relative to a cord plane and a collector holder for holding a collector frame for receiving the plurality of cord collectors relative to the insert holder.

35. The cord organizer according to claim 16, wherein the cord organizer comprises a cord fault detector for detecting faults in the cords between the tire building creel and the extruder.

36. The cord organizer according to claim 35, wherein the cord fault detector comprises a cord fault catcher with a plurality of catch channels for threading each cord of the groups of cords through a different catch channel of the plurality of catch channels and one or more catch sensors for detecting displacement of the cord fault catcher in a cord direction as a result of a faulty cord getting stuck in one catch channel of the plurality of catch channels.

37. The cord organizer according to claim 36, wherein the cord inlay station further comprises a catcher holder for holding the cord fault catcher with the plurality of catch channels extending in a cord plane in-line with the cord direction.

38. The cord organizer according to claim 37, wherein the cord inlay station comprises an insert holder for holding one or more extruder inserts relative to the cord plane, wherein the cord fault catcher is separable from the catcher holder with the cords threaded through the catch channels for transfer of said cord fault catcher together with the one or more extruder inserts to the extruder.

39. The cord organizer according to claim 16, wherein the cord inlay station is mobile.

40. The cord organizer according to claim 39, wherein the cord inlay station comprises a coupling member for coupling or aligning the cord inlay station with the tire building creel.

41-44. (canceled)
